(19) United States
(12) Patent Application Publication
(10) Pub. No.: US 2024/0182046 A1
(43) Pub. Date: Jun. 6, 2024

(54) VEHICLE-MOUNTED COMMUNICATION SYSTEM, SWITCH DEVICE, ABNORMALITY DETECTING METHOD, AND ABNORMALITY DETECTING PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Jun YUMOTO, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/284,870

(22) PCT Filed: Feb. 10, 2022
(86) PCT No.: PCT/JP2022/005389

§ 371 Date: Sep. 29, 2023

(30) Foreign Application Priority Data
Mar. 30, 2021 (JP) 2021-056355

(51) Int. Cl. B60W 50/02; B60R 16/023; B60W 50/029

(52) U.S. Cl. CPC B60W 50/0205; B60R 16/0232; B60W 50/029; B60W 2050/021

(57) ABSTRACT

An in-vehicle communication system is provided with an in-vehicle device group including four or more in-vehicle devices. A specific in-vehicle device group, which is a part of the in-vehicle device group and includes three or more specific in-vehicle devices being the in-vehicle devices, circulates a specific target packet. A first in-vehicle device being the specific in-vehicle device performs a detection process of detecting abnormality of a specific in-vehicle device, other than the first in-vehicle device, in the specific in-vehicle device group, based on a reception state of the target packet.

### TECHNICAL FIELD

The present disclosure relates to an in-vehicle communication system, a switch device, an abnormality detection method, and an abnormality detection program.

This application claims priority on Japanese Patent Application No. 2021-56355 filed on Mar. 30, 2021, the entire content of which is incorporated herein by reference.

### BACKGROUND ART

Japanese Laid-Open Patent Publication No. 2018-174480 (PATENT LITERATURE 1) discloses a relay device in an in-vehicle network, as follows. That is, the relay device performs a relay process of relaying data between a plurality of function units installed in a vehicle. The relay device includes: a counting unit that counts the number of relay packets, i.e., the number of packets to be relayed to target function units that are a plurality of function units of the same category, in the relay process; and a detection unit that monitors the count value of the counting unit, and detects unauthorized communication to the target function unit, based on a maximum value and a minimum value of the number of relay packets counted by the counting unit.

### CITATION LIST

### Patent Literature

PATENT LITERATURE 1: Japanese Laid-Open Patent Publication No. 2018-174480

### SUMMARY OF THE INVENTION

An in-vehicle communication system of the present disclosure is an in-vehicle communication system provided with an in-vehicle device group including four or more in-vehicle devices. A specific in-vehicle device group, which is a part of the in-vehicle device group and includes three or more specific in-vehicle devices being the in-vehicle devices, circulates a specific target packet. A first in-vehicle device being the specific in-vehicle device performs a detection process of detecting abnormality of a specific in-vehicle device, other than the first in-vehicle device, in the specific in-vehicle device group, based on a reception state of the target packet.

A switch device of the present disclosure is a switch device in an in-vehicle communication system provided with an in-vehicle device group that includes four or more in-vehicle devices including the switch device. The switch device includes: a relay unit configured to relay a packet between the in-vehicle devices; and a detection unit configured to detect abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

An abnormality detection method of the present disclosure is an abnormality detection method in an in-vehicle communication system provided with an in-vehicle device group including four or more in-vehicle devices. The method includes: circulating a specific target packet by a specific in-vehicle device group that is a part of the in-vehicle device group and includes three or more specific in-vehicle devices being the in-vehicle devices; and performing, by a first in-vehicle device being the specific in-vehicle device, a detection process of detecting abnormality of a specific in-vehicle device, other than the first in-vehicle device, in the specific in-vehicle device group, based on a reception state of the target packet.

An abnormality detection method of the present disclosure is an abnormality detection method used by a switch device in an in-vehicle communication system provided with an in-vehicle device group including four or more in-vehicle devices including the switch device. The method includes: relaying a packet between the in-vehicle devices; and detecting abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

An abnormality detection program of the present disclosure is an abnormality detection program used in a switch device in an in-vehicle communication system provided with an in-vehicle device group including four or more in-vehicle devices including the switch device. The program causes a computer to function as: a relay unit configured to relay a packet between the in-vehicle devices: and a detection unit configured to detect abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

One mode of the present disclosure can be realized not only as an in-vehicle communication system that includes such characteristic processing units but also as a program that causes a computer to execute such characteristic processes.

One mode of the present disclosure can be realized not only as a switch device that includes such characteristic processing units but also as a semiconductor integrated circuit that realizes a part of or the entire switch device.

### BRIEF DESCRIPTION OF DRAWINGS

FIG. 1 shows a configuration of an in-vehicle communication system according to an embodiment of the present disclosure.

FIG. 2 shows a configuration of a switch device according to the embodiment of the present disclosure.

FIG. 3 shows an example of rule information stored in the switch device according to the embodiment of the present disclosure.

FIG. 4 illustrates a flow of a target packet being relayed by the switch device according to the embodiment of the present disclosure.

FIG. 5 shows an example of an address table stored in the switch device according to the embodiment of the present disclosure.

FIG. 6 shows a configuration of a target function unit according to the embodiment of the present disclosure.

FIG. 7 shows a configuration of a modification of the in-vehicle communication system according to the embodiment of the present disclosure.

FIG. 8 shows an example of a sequence of a target packet circulation process in the in-vehicle communication system according to the embodiment of the present disclosure.

FIG. 9 is a flowchart showing an example of an operation procedure when a switch device, which generates a target packet, relays a target packet, in the in-vehicle communication system according to the embodiment of the present disclosure.

FIG. 10 is a flowchart showing an example of an operation procedure when a switch device, which does not generate a target packet, relays a target packet, in the in-vehicle communication system according to the embodiment of the present disclosure.

FIG. 11 is a flowchart showing an example of an operation procedure when a target function unit in the in-vehicle communication system performs a target packet circulation process, according to the embodiment of the present disclosure.

FIG. 12 is a flowchart showing an example of an operation procedure when a switch device in the in-vehicle communication system performs a detection process, according to the embodiment of the present disclosure.

FIG. 13 is a flowchart showing an example of an operation procedure when a target function unit in the in-vehicle communication system performs a detection process, according to the embodiment of the present disclosure.

FIG. 14 shows an example of a sequence of a threshold value update process due to addition of a specific in-vehicle device, in Modification 3 of the in-vehicle communication system according to the embodiment of the present disclosure.

### DETAILED DESCRIPTION

Conventionally, technologies regarding in-vehicle networks including a plurality of in-vehicle devices have been developed.

### Problems to be Solved by the Present Disclosure

Beyond the technology described in PATENT LITERATURE 1, there is a demand for a technology that can more reliably detect abnormality of an in-vehicle device in an in-vehicle communication system by using an easier method.

The present disclosure has been made to solve the above problem, and an object of the present disclosure is to provide an in-vehicle communication system, a switch device, an abnormality detection method, and an abnormality detection program that can more reliably detect abnormality of an in-vehicle device in an in-vehicle communication system by using an easier method.

### Effects of the Present Disclosure

According to the present disclosure, abnormality of an in-vehicle device in an in-vehicle communication system can be more reliably detected by using an easier method.

### Description of Embodiment of the Present Disclosure

First, contents of embodiments of the present disclosure will be listed and described.

(1) An in-vehicle communication system according to an embodiment of the present disclosure is an in-vehicle communication system provided with an in-vehicle device group including four or more in-vehicle devices. A specific in-vehicle device group, which is a part of the in-vehicle device group and includes three or more specific in-vehicle devices being the in-vehicle devices, circulates a specific target packet. A first in-vehicle device being the specific in-vehicle device performs a detection process of detecting abnormality of a specific in-vehicle device, other than the first in-vehicle device, in the specific in-vehicle device group, based on a reception state of the target packet.

According to the above configuration, when abnormality occurs in at least one of the plurality of specific in-vehicle devices in the specific in-vehicle device group, another specific in-vehicle device can detect this abnormality. That is, the plurality of specific in-vehicle devices in the specific in-vehicle device group can mutually detect abnormalities, whereby abnormality detection can be more reliably performed.

Furthermore, each of the specific in-vehicle devices monitors the reception state, in the in-vehicle device, of the target packet circulating through the specific in-vehicle device group, whereby abnormality in the specific in-vehicle device group can be detected. Therefore, for example, it is not necessary to monitor packets for each in-vehicle device to be a communication partner, and the detection process can be performed by a simpler configuration. Therefore, abnormality of an in-vehicle device in the in-vehicle communication system can be more reliably detected by using an easier method.

(2) The specific in-vehicle device group includes a plurality of first in-vehicle devices, and at least one of the plurality of first in-vehicle devices is a switch device that relays a packet between a plurality of in-vehicle devices. If one or more first in-vehicle devices, other than the switch device, in the specific in-vehicle device group detects abnormality of an in-vehicle device in the detection process, the one or more first in-vehicle devices may change a process, other than the detection process, performed by the first in-vehicle device to a process with low load, or may stop the process.

For example, in the in-vehicle communication system, the plurality of specific in-vehicle devices in the specific in-vehicle device group are associated with each other to realize functions for vehicle traveling, various services to be provided, and the like. Therefore, if abnormality occurs in at least one of the specific in-vehicle devices, the above functions are not likely to be realized even when the specific in-vehicle device having no abnormality performs a normal process.

Therefore, as described above, when the first in-vehicle device, other than the switch device, in the specific in-vehicle device group has detected abnormality of a specific in-vehicle device other than the first in-vehicle device in the specific in-vehicle device group, the process that is performed by the first in-vehicle device and is highly likely to become unnecessary is changed to a process with low load, or is stopped. Thus, the processing load in the first in-vehicle device can be appropriately reduced.

(3) All the specific in-vehicle devices in the specific in-vehicle device group may be the first in-vehicle devices.

For example, if one specific in-vehicle device in the specific in-vehicle device group is configured to perform the detection process and abnormality occurs in this specific in-vehicle device, the abnormality of the specific in-vehicle device is not likely to be accurately detected. Meanwhile, when the plurality of specific in-vehicle devices are configured to perform the detection process as described above, abnormality detection can be more reliably performed.

(4) The specific in-vehicle device group may include, as the specific in-vehicle devices, a switch device that relays a packet between the plurality of in-vehicle devices, a second in-vehicle device, and a third in-vehicle device. The switch device may hold rule information indicating a circulation rule of the target packet, and may, based on the rule information, transmit the target packet received from the second in-vehicle device to the third in-vehicle device.

According to the above configuration, the second in-vehicle device in the specific in-vehicle device group can transmit the target packet without being conscious of the address of the third in-vehicle device to be the transmission destination of the target packet. Therefore, for example, even if the vendors of the plurality of specific in-vehicle devices are different from each other, abnormality detection by the circulating target packet can be more reliably performed.

(5) The specific in-vehicle device group may include, as the specific in-vehicle devices, a switch device that relays a packet between the plurality of in-vehicle devices, a second in-vehicle device, and a third in-vehicle device. The second in-vehicle device may overwrite a destination address of the target packet received from the switch device with an address of the third in-vehicle device, and transmit the target packet to the switch device.

According to the above configuration, the switch device need not hold information indicating a target packet circulation rule, etc. Therefore, the structure of the switch device can be simplified.

(6) In the detection process, if the first in-vehicle device cannot confirm circulation of the target packet even when an elapsed time from transmission of the target packet has reached or exceeded a predetermined threshold value, the first in-vehicle device may determine that the abnormality occurs. When a new specific in-vehicle device has been added to the specific in-vehicle device group, the first in-vehicle device may perform an update process of updating the predetermined threshold value.

According to the above configuration, when a new specific in-vehicle device is added to the in-vehicle network, the threshold value is updated according to the addition of the specific in-vehicle device, and abnormality in a new specific in-vehicle device group can be detected.

(7) The first in-vehicle device performing the update process may notify another first in-vehicle device in the specific in-vehicle device group, of the updated threshold value. The other first in-vehicle device may perform the detection process by using the notified updated threshold value.

According to the above configuration, abnormality in a new specific in-vehicle device group can be detected in each first in-vehicle device, and update of the threshold value in each first in-vehicle device can be more efficiently performed.

(8) The first in-vehicle device performing the update process may notify another first in-vehicle device in the specific in-vehicle device group, of a correction value of the threshold value. The other first in-vehicle device may update the threshold value, based on the notified correction value, and perform the detection process by using the updated threshold value.

According to the above configuration, abnormality in a new specific in-vehicle device group can be detected in each first in-vehicle device. In addition, when the threshold value calculation method varies among the first in-vehicle devices, for example, the threshold value can be correctly updated in each first in-vehicle device.

(9) The specific in-vehicle device group may include three or more specific in-vehicle devices that are essential for automated driving of a vehicle.

According to the above configuration, abnormality that occurs in at least one of the plurality of specific in-vehicle devices used for automated driving can be more reliably detected.

(10) A switch device according to the embodiment of the present disclosure is a switch device in an in-vehicle communication system provided with an in-vehicle device group that includes four or more in-vehicle devices including the switch device. The switch device includes: a relay unit configured to relay a packet between the in-vehicle devices; and a detection unit configured to detect abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

According to the above configuration, when abnormality occurs in at least one of the plurality of specific in-vehicle devices in the specific in-vehicle device group, this abnormality can be detected in the switch device.

Furthermore, the switch device monitors the reception state, in the switch device, of the target packet circulating through the specific in-vehicle device group, whereby abnormality in the specific in-vehicle device group can be detected. Therefore, for example, it is not necessary to monitor packets for each in-vehicle device to be a communication partner, and the detection process can be performed by a simpler configuration. Therefore, abnormality of an in-vehicle device in the in-vehicle communication system can be more reliably detected by using an easier method.

(11) An abnormality detection method according to the embodiment of the present disclosure is an abnormality detection method in an in-vehicle communication system provided with an in-vehicle device group including four or more in-vehicle devices. The method includes: circulating a specific target packet by a specific in-vehicle device group that is a part of the in-vehicle device group and includes three or more specific in-vehicle devices being the in-vehicle devices; and performing, by a first in-vehicle device being the specific in-vehicle device, a detection process of detecting abnormality of a specific in-vehicle device, other than the first in-vehicle device, in the specific in-vehicle device group, based on a reception state of the target packet.

According to the above method, when abnormality occurs in at least one of the plurality of specific in-vehicle devices in the specific in-vehicle device group, another specific in-vehicle device can detect this abnormality. That is, the plurality of specific in-vehicle devices in the specific in-vehicle device group can mutually detect abnormalities, whereby abnormality detection can be more reliably performed.

Furthermore, each of the specific in-vehicle devices monitors the reception state, in the in-vehicle device, of the target packet circulating through the specific in-vehicle device group, whereby abnormality in the specific in-vehicle device group can be detected. Therefore, for example, it is not necessary to monitor packets for each in-vehicle device to be a communication partner, and the detection process can be performed by a simpler configuration. Therefore, abnormality of an in-vehicle device in the in-vehicle communication system can be more reliably detected by using an easier method.

(12) An abnormality detection method according to the embodiment of the present disclosure is an abnormality detection method used by a switch device in an in-vehicle communication system provided with an in-vehicle device group including four or more in-vehicle devices including the switch device. The method includes: relaying a packet between the in-vehicle devices; and detecting abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

According to the above method, when abnormality occurs in at least one of the plurality of specific in-vehicle devices in the specific in-vehicle device group, the switch device can detect this abnormality.

Furthermore, the switch device monitors the reception state, in the switch device, of the target packet circulating through the specific in-vehicle device group, whereby abnormality in the specific in-vehicle device group can be detected. Therefore, for example, it is not necessary to monitor packets for each in-vehicle device to be a communication partner, and the detection process can be performed by a simpler configuration. Therefore, abnormality of an in-vehicle device in the in-vehicle communication system can be more reliably detected by using an easier method.

(13) An abnormality detection program according to the embodiment of the present disclosure is an abnormality detection program used in a switch device in an in-vehicle communication system provided with an in-vehicle device group including four or more in-vehicle devices including the switch device. The program causes a computer to function as: a relay unit configured to relay a packet between the in-vehicle devices; and a detection unit configured to detect abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

According to the above configuration, when abnormality occurs in at least one of the plurality of specific in-vehicle devices in the specific in-vehicle device group, this abnormality can be detected in the switch device.

Furthermore, the switch device monitors the reception state, in the switch device, of the target packet circulating through the specific in-vehicle device group, whereby abnormality in the specific in-vehicle device group can be detected. Therefore, for example, it is not necessary to monitor packets for each in-vehicle device to be a communication partner, and the detection process can be performed by a simpler configuration. Therefore, abnormality of an in-vehicle device in the in-vehicle communication system can be more reliably detected by using an easier method.

Hereinafter, the embodiments of the present disclosure will be described with reference to the drawings. In the drawings, the same or corresponding parts are denoted by the same reference signs, and descriptions thereof are not repeated. At least some parts of the embodiments described below may be combined together as desired.

### <Configuration and Basic Operation>

### [Overall Configuration]

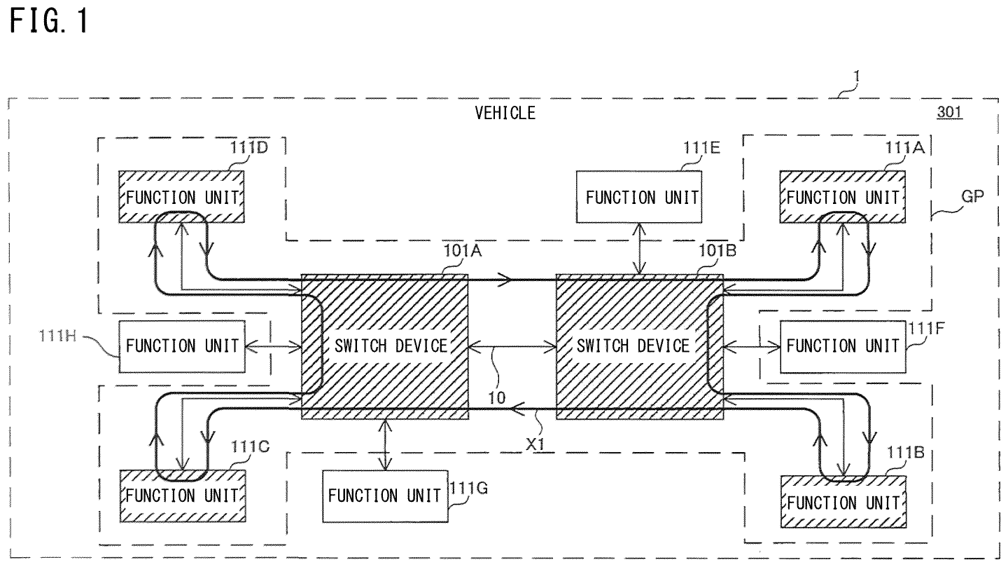

FIG. 1 shows a configuration of an in-vehicle communication system according to an embodiment of the present disclosure.

With reference to FIG. 1, an in-vehicle communication system 301 is installed in a vehicle 1, and is provided with an in-vehicle device group including four or more in-vehicle devices. More specifically, the in-vehicle communication system 301 includes one or a plurality of switch devices 101 and a plurality of function units 111, which are examples of in-vehicle devices.

FIG. 1 shows two switch devices 101A, 101B being examples of the switch devices 101, and eight function units 111A to 111H being examples of the function units 111. The switch devices 101 and the function units 111 are ECUs (Electronic Control Units), for example.

One switch device 101 is connected to the plurality of function units 111 and to the other switch device 101 through Ethernet (registered trademark) cables 10, for example, and is capable of communicating with the plurality of function units 111 or the other switch device 101 connected thereto.

Specifically, the switch device 101 performs a relay process of relaying a packet from a function unit Ill to another function unit 111 or the other switch device 101. For example, information is exchanged between the switch device 101 and the function unit 111 or between the two switch devices 101 by using an Ethernet frame having an IP packet stored therein.

Each function unit 111 is, for example, a target function unit required for automated driving of the vehicle 1, or a non-target function unit other than the target function unit. Examples of the target function unit include an extra-vehicular communication ECU, a sensor, a camera, a LIDAR (Light Detection and Ranging), an automated driving processing ECU, and the like. Examples of the non-target function unit include an air conditioner control device, audio equipment, and the like. The target function unit may be a function unit used in an application other than automated driving.

Here, it is assumed that four function units 111A to 111D are “target function units”, and four function units 111E to 111H are “non-target function units”. In FIG. 1, the four target function units and the two switch devices 101 are hatched. Hereinafter, a group including six specific in-vehicle devices, i.e., the four target function units and the two switch devices 101, is referred to as “specific in-vehicle device group GP”. A specific in-vehicle device group includes a plurality of specific in-vehicle devices, and includes one or more first in-vehicle devices that are specific in-vehicle devices performing a detection process described later. The first in-vehicle device performing the detection process may be a target function unit or a switch device 101.

The specific in-vehicle device group GP is not limited to the configuration including six specific in-vehicle devices, i.e., four target function units and two switch devices 101. For example, the specific in-vehicle device group GP may include three, four, five, or seven or more specific in-vehicle devices. The specific in-vehicle device group GP may include one or three or more switch devices, or may not include a switch device 101 as in Modification 2 described later.

The specific in-vehicle device group GP, being a part of an in-vehicle device group, circulates a specific target packet used for detection of abnormality of a specific in-vehicle device in the specific in-vehicle device group GP. That is, the target packet sequentially passes through the specific in-vehicle devices in the specific in-vehicle device group GP.

For example, when a target packet has been transmitted from the switch device IOLA, this target packet circulates through the switch device 101B, the function unit 111A, the switch device 101B, the function unit 111B, the switch device 101B, the switch device 101A, the function unit 111C, the switch device 101A, and the function unit 111D in this order as indicated by an arrow X1 in FIG. 1, and reaches the switch device 101A again.

The first in-vehicle device in the specific in-vehicle device group GP performs a detection process of detecting abnormality of a specific in-vehicle device other than the first in-vehicle device in the specific in-vehicle device group GP, based on the reception state of the target packet circulating through the specific in-vehicle device group GP.

Here, as one example, all the specific in-vehicle devices, i.e., the four target function units and the two switch devices 101, in the specific in-vehicle device group GP each perform, as the first in-vehicle device, a detection process of detecting abnormality in the other specific in-vehicle devices. Hereinafter, the specific configurations of the switch devices 101 and the target function units will be described.

### [Configurations of Switch Device and Target Function Unit]

### (Switch Device)

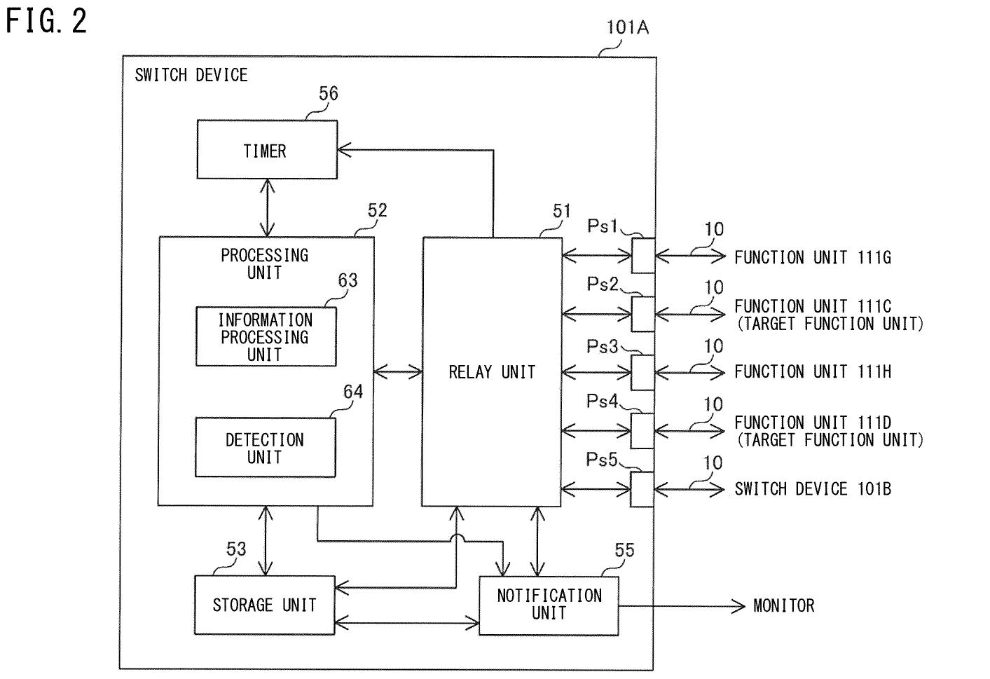

FIG. 2 shows the configuration of a switch device according to the embodiment of the present disclosure. Here, the configuration of the switch device 101A will be described. The switch device 101B has the same configuration as the switch device 101A.

With reference to FIG. 2, the switch device 101 includes a relay unit 51, a processing unit 52, a storage unit 53, a plurality of communication ports Ps, a notification unit 55, and a timer 56. The relay unit 51, the processing unit 52, and the notification unit 55 are each implemented by a processor such as a CPU (Central Processing Unit) or a DSP (Digital Signal Processor), for example. The storage unit 53 is a nonvolatile memory, for example. The processing unit 52 includes an information processing unit 63 and a detection unit 64.

The communication ports Ps are terminals to which the Ethernet cables 10 are connectable, for example. The communication ports Ps may be terminals of an integrated circuit. Each of the plurality of communication ports Ps is connected to any one of the plurality of function units 111 via the Ethernet cable 10.

In this example, a communication port Ps1 being the communication port Ps is connected to the function unit 111G, and a communication port Ps2 being the communication port Ps is connected to the function unit 111C. A communication port Ps3 being the communication port Ps is connected to the function unit 111H, and a communication port Ps4 being the communication port Ps is connected to the function unit 111D. A communication port Ps5 being the communication port Ps is connected to the switch device 101B.

### (a) Relay Process

The relay unit 51 relays a packet between the in-vehicle devices. That is, upon receiving an Ethernet frame, transmitted from a function unit 111 or the switch device 101B, via a communication port Ps corresponding to the function unit 111 or the switch device 101B, the relay unit 51 performs a relay process for the received Ethernet frame to transmit the Ethernet frame to a function unit 111 or the switch device 101B.

The relay unit 51 performs a relay process for a target packet and a non-target packet other than the target packet, taking into consideration the congestion state, etc., in the in-vehicle communication system 301, for example. The relay unit 51 may perform the relay process for the target packet in preference to that for the non-target packet, for example.

In the storage unit 53, rule information indicating a circulation rule unique to the target packet is stored. The relay unit 51, based on the rule information, transmits a target packet received from a second in-vehicle device being a specific in-vehicle device to a third in-vehicle device being a specific in-vehicle device.

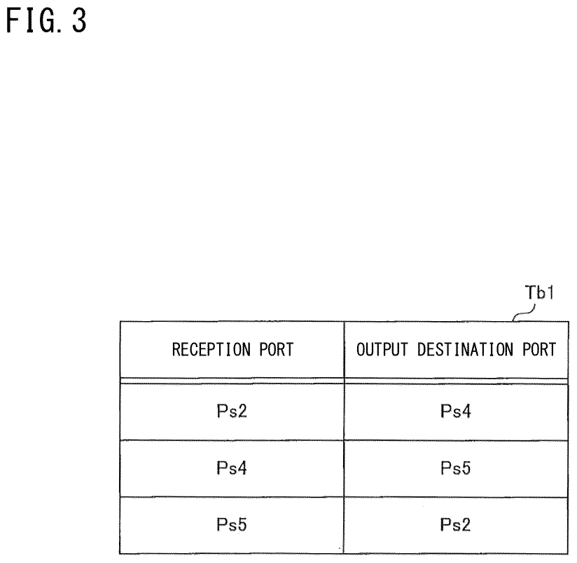

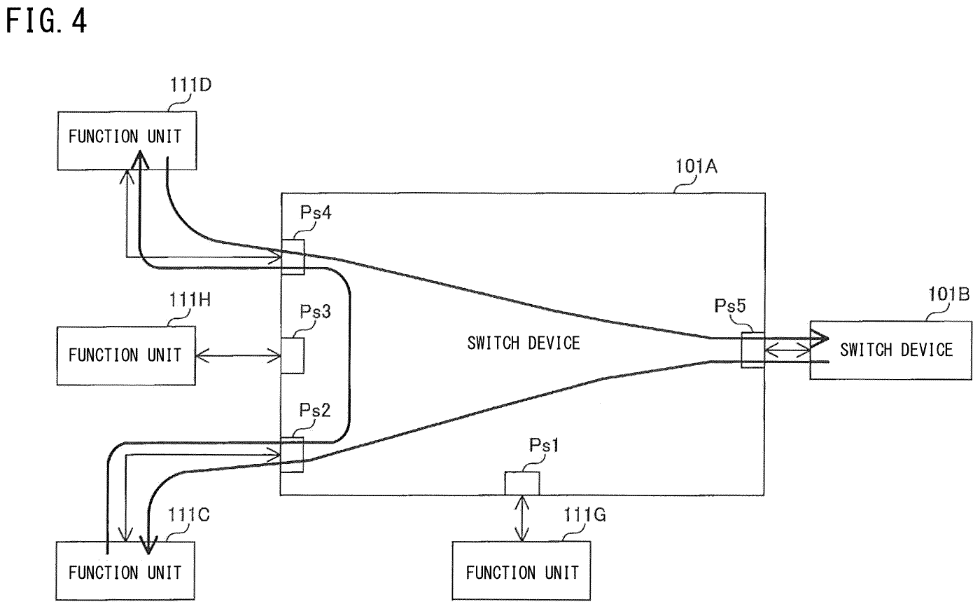

FIG. 3 shows an example of the rule information stored in the switch device according to the embodiment of the present disclosure. FIG. 4 illustrates a flow of a target packet being relayed by the switch device according to the embodiment of the present disclosure.

More specifically, with reference to FIG. 3 and FIG. 4, the storage unit 53 has stored therein a port table Tb1 as one example of the rule information. The port table Tb indicates correspondence between communication ports Ps that receive target packets, and communication ports Ps to which the target packets are outputted.

Specifically, the port table Tb1 indicates that when a target packet is received from the communication port Ps2, the target packet is outputted to the communication port Ps4, that when a target packet is received from the communication port Ps4, the target packet is outputted to the communication port Ps5, and that when a target packet is received from the communication port Ps5, the target packet is outputted to the communication port Ps2.

Upon receiving an Ethernet frame from one of the plurality of communication ports Ps, the relay unit 51, for example, checks the value of a type field in a header portion of the Ethernet frame, thereby confirming whether or not the packet stored in the Ethernet frame is a target packet.

When the packet is a target packet, the relay unit 51 specifies a communication port Ps to be an output destination of the packet, with reference to the port table Tb1 stored in the storage unit 53. Then, the relay unit 51 transmits the Ethernet frame having the packet stored therein, from the specified communication port Ps.

When the relay unit 51 performs the target packet relay process according to the above method, for example, as shown in FIG. 4, the target packet transmitted from the function unit 111C is transmitted to the function unit 111D via the switch device 101A. The target packet transmitted from the function unit 111D is transmitted to the switch device 101B via the switch device 101A. The target packet transmitted from the switch device 101B is transmitted to the function unit 111C via the switch device 101A.

The rule information stored in the storage unit 53 is not limited to the port table Tb1 shown in FIG. 3. The rule information may be information indicating correspondence between MAC (Media Access Control) addresses of target function units that are target packet transmission sources, and MAC addresses of target function units that are target packet transmission destinations.

The storage unit 53 has stored therein an address table Tb2 indicating correspondence between the communication ports Ps, and MAC addresses of the function units Ill and the switch device 101B to which the communication ports Ps are connected.

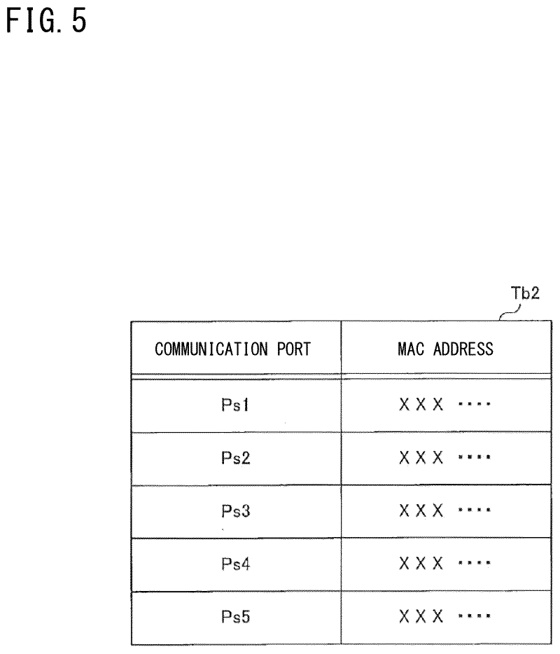

FIG. 5 shows an example of an address table stored in the switch device according to the embodiment of the present disclosure.

With reference to FIG. 5, if a packet received from any one of the plurality of communication ports Ps is not a target packet, the relay unit 51 checks a transmission destination MAC address included in an Ethernet frame having this packet stored therein. Then, the relay unit 51 specifies a communication port Ps corresponding to the transmission destination MAC address with reference to the address table Tb2 stored in the storage unit 53, and transmits the Ethernet frame from the specified communication port Ps.

### (b) Detection Process

Referring back to FIG. 2 and FIG. 4, the information processing unit 63, for example, generates a target packet when the switch device 101A is activated, and transmits the generated target packet to the switch device 101B via the relay unit 51 and the communication port Ps5. As described above, this target packet circulates through the switch device 101B, the function unit 111A, the switch device 101B, the function unit 111B, the switch device 101B, the switch device 101A, the function unit 111C, the switch device 101A, and the function unit 111D in this order, and reaches the switch device 101A again.

Generation of a target packet is performed by any one of the plurality of specific in-vehicle devices in the specific in-vehicle device group GP. Therefore, when the information processing unit 63 in the switch device 101A generates a target packet as described above, the information processing unit 63 in the switch device 101B does not perform generation of a target packet.

Generation of a target packet may be performed by a specific in-vehicle device, other than the switch device 101A, in the specific in-vehicle device group GP.

The detection unit 64 performs a detection process of detecting abnormality of a specific in-vehicle device other than the switch device 101A in the specific in-vehicle device group GP, based on the reception state of the target packet in the switch device 101A. For example, if the reception state is such that circulation of a target packet transmitted from the switch device 101A cannot be confirmed even after a predetermined time or more has elapsed from the transmission, that is, if the target packet does not return after going around the specific in-vehicle device group GP, the detection unit 64 determines that abnormality occurs in the specific in-vehicle device in the specific in-vehicle device group GP.

The state where abnormality of a specific in-vehicle device occurs is, for example, a state where data processing cannot be performed in the specific in-vehicle device because of frozen software or the like in the specific in-vehicle device.

More specifically, at a timing when a target packet generated by the information processing unit 63 is transmitted from the communication port Ps5, the relay unit 51 causes the timer 56 to start a count operation. Upon receiving the target packet that has circulated through the specific in-vehicle device group GP, i.e., upon receiving the target packet via the communication port Ps4, the relay unit 51 resets the count value of the timer 56.

The detection unit 64 checks the count value of the timer 56 to measure a circulation time that is a time period from the transmission timing of the target packet to the circulation completion timing of the target packet, in the switch device 101A.

A threshold value for the circulation time is stored in the storage unit 53. The threshold value is set in advance, taking into consideration a propagation delay time of data between specific in-vehicle devices, a data processing time in each specific in-vehicle device, etc., for example.

With reference to the threshold value stored in the storage unit 53, when the count value of the timer 56 has exceeded the threshold value, the detection unit 64 determines that automated driving of the vehicle 1 is difficult because abnormality occurs in one or a plurality of specific in-vehicle devices in the specific in-vehicle device group GP. In this case, the detection unit 64 outputs determination information indicating the determination result to the notification unit 55.

Upon receiving the determination information from the detection unit 64, the notification unit 55, for example, displays the content of the determination information on a monitor or the like installed in the vehicle 1 to notify the user of the content, and stores the determination information in association with the present time, etc., in the storage unit 53.

The notification unit 55, for example, transmits the determination information to one or a plurality of specific in-vehicle devices in the specific in-vehicle device group GP via the relay unit 51 and the corresponding communication port Ps. That is, the notification unit 55 transmits the determination information to the function units 111A, 111B, 111C, 111D being target function units, directly or via the switch device 101B.

The detection unit 64 may use a method other than the method of confirming the circulation time as described above, for the detection process of detecting abnormality of a specific in-vehicle device in the specific in-vehicle device group GP. For example, the detection unit 64 may detect abnormality of a specific in-vehicle device in the specific in-vehicle device group GP by confirming whether or not a payload part in an Ethernet frame received by the relay unit 51 is normal as the reception state of the target packet.

### (Target Function Unit)

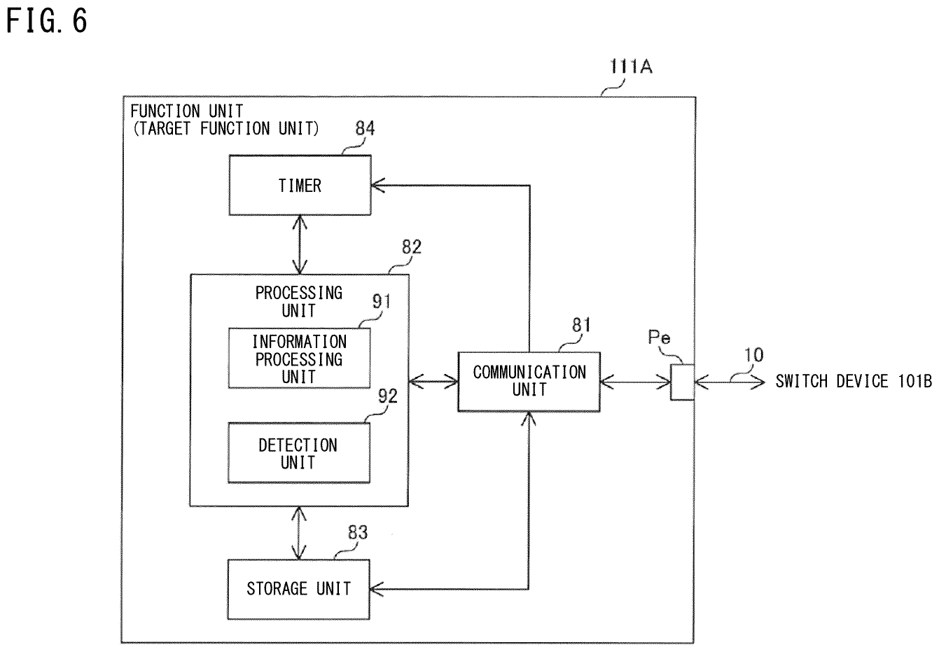

FIG. 6 shows the configuration of a target function unit according to the embodiment of the present disclosure. Here, the configuration of the function unit 111A being a target function unit will be described. The function units 111B, 111C, 111D being the other target function units have the same configuration as the function unit 111A.

With reference to FIG. 6, the function unit 111A includes a communication unit 81, a processing unit 82, a storage unit 83, a timer 84, and a communication port Pe. The processing unit 82 is implemented by a processor such as a CPU or a DSP, for example. The communication unit 81 is implemented by a processor, or a communication circuit such as a communication IC (Integrated Circuit), for example. The storage unit 83 is a nonvolatile memory, for example. The processing unit 82 includes an information processing unit 91 and a detection unit 92.

The communication port Pe is a terminal to which, for example, the Ethernet cable 10 is connectable. The communication port Pe may be a terminal of an integrated circuit, or the like. The communication port Pe is connected to the switch device 101B via the Ethernet cable 10.

### (a) Circulation Process

When the communication unit 81 has received an Ethernet frame transmitted from the switch device 101B via the communication port Pe, the communication unit 81 confirms, for example, the value of a type field in a header portion of the Ethernet frame, to confirm whether or not a packet stored in the Ethernet frame is a target packet.

When the packet is a target packet, the communication unit 81 transmits the Ethernet frame having this packet stored therein, to the switch device 101B via the communication port Pe.

On the other hand, when the packet is not a target packet, the communication unit 81, for example, extracts information included in the packet, and outputs the extracted information to the information processing unit 91. Upon receiving the information outputted from the communication unit 81, the information processing unit 91 performs normal information processing using the information.

### (b) Detection Process

The detection unit 92 performs a detection process by the same method as that for the detection unit 64 in the switch device 101. That is, the detection unit 92 performs a detection process of detecting abnormality of another specific in-vehicle device in the specific in-vehicle device group GP, based on the reception state of the target packet in the function unit 111A.

More specifically, upon receiving the target packet, the communication unit 81 causes the timer 84 to start a count operation, at a timing when the target packet is transmitted from the communication port Pe, for example. Furthermore, upon receiving the target packet that has circulated through the specific in-vehicle device group GP, i.e., upon receiving the target packet via the communication port Pe, the communication unit 81 resets the count value of the timer 84.

The detection unit 92 checks the count value of the timer 56 to measure a circulation time that is a time period from the transmission timing of the target packet to the circulation completion timing of the target packet in the function unit 111A.

A threshold value of the circulation time is stored in the storage unit 83. With reference to the threshold value stored in the storage unit 83, when the count value of the timer 84 has exceeded the threshold value, the detection unit 92 determines that automated driving of the vehicle 1 is difficult because abnormality occurs in one or a plurality of specific in-vehicle devices in the specific in-vehicle device group GP. In this case, the detection unit 92 outputs determination information indicating the determination result to the information processing unit 91.

Upon receiving the determination information from the detection unit 92, the information processing unit 91 changes the process, other than the detection process, performed by the function unit 111A to a process with low load, or stops the process. For example, when the function unit 111A is a sensor, the information processing unit 91 stops the measurement process. For example, when the function unit 111A is a camera, the information processing unit 91 performs a process of reducing image resolution. Furthermore, for example, upon receiving the determination information from the switch device 101 via the communication unit 81, the information processing unit 91 performs a similar process.

The detection unit 92 may not necessarily output the determination information to the information processing unit 91, and the information processing unit 91 may not necessarily change the process, other than the detection process, performed by the function unit 111A to a process with low load, or stop the process. For example, upon determining that abnormality occurs, the detection unit 92 may transmit the determination information to the switch device 101B via the communication unit 81 and the communication port Pe, without outputting the determination information to the information processing unit 91. In this case, the function unit 111A continues the normal processing.

Upon receiving the determination information from the function unit 111A, the relay unit 51 in the switch device 101B outputs the determination information to the notification unit 55, for example. Then, the notification unit 55, for example, displays the content of the determination information received from the relay unit 51 on the monitor or the like installed in the vehicle 1 to notify the user of the content, and stores the determination information in association with the present time, etc., in the storage unit 53.

In the in-vehicle communication system 301, not all the specific in-vehicle devices in the specific in-vehicle device group GP may perform the detection process as the first in-vehicle device. One or a plurality of specific in-vehicle devices corresponding to a part of the specific in-vehicle device group GP may perform the detection process as the first in-vehicle device. In this case, the specific in-vehicle device that circulates the target packet may be the first in-vehicle device that performs the detection process, or may be the specific in-vehicle device that does not perform the detection process.

The specific in-vehicle device group GP may further include, as specific in-vehicle devices, one or a plurality of non-target function units, in addition to the target function units and the switch device 101.

### Modification 1

The switch device 101 may not necessarily store therein the rule information such as the port table Tb1. In this case, for example, in the storage unit 83 of each target function unit, address information of target function units, which are specific in-vehicle devices other than the switch devices 101A, 101B and are transmission destinations of a target packet, is stored in advance.

Upon receiving an Ethernet frame having a target packet stored therein, the communication unit 81 in each target function unit (second in-vehicle device), for example, overwrites the destination address of the Ethernet frame with the MAC address indicated by the address information stored in the storage unit 83, and transmits the Ethernet frame to the switch devices 101A, 101B via the communication port Pe.

Upon receiving the Ethernet frame transmitted from the target function unit, the relay unit 51 in the switch device 101 specifies a communication port Ps corresponding to the transmission destination MAC address included in the Ethernet frame, with reference to the address table Tb2 shown in FIG. 5. Then, the relay unit 51 transmits the Ethernet frame from the specified communication port Ps to the target function unit (third in-vehicle device).

### Modification 2

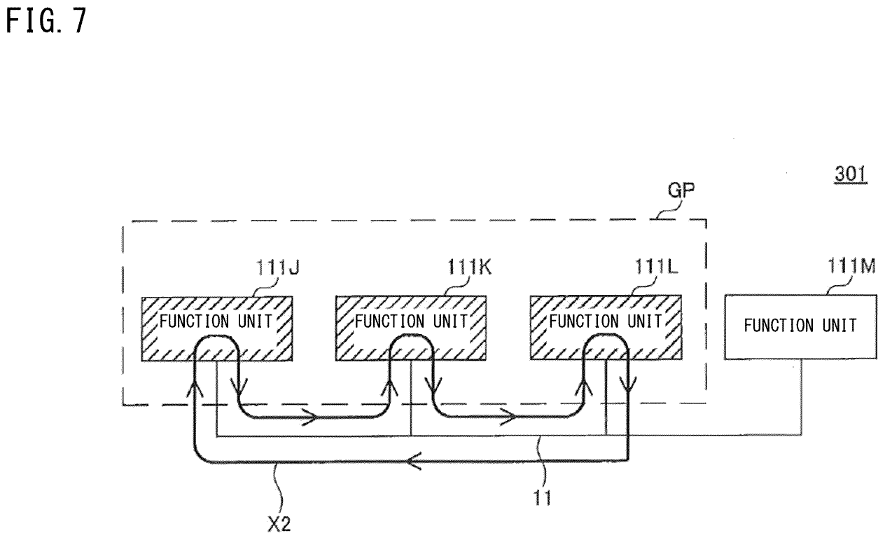

The in-vehicle communication system 301 may not necessarily include the switch device 101. FIG. 7 shows the configuration of a modification of the in-vehicle communication system according to the embodiment of the present disclosure.

With reference to FIG. 7, the in-vehicle communication system 301 is provided with an in-vehicle device group including four function units 111, i.e., 111J to 111M, for example. It is assumed that the function units 111J, 11K, 11L being a part of the in-vehicle device group are target function units and the function unit 111M is a non-target function unit. These four function units 111 are connected to each other via a CAN bus 11 conforming to the standard of CAN (Controller Area Network) (registered trademark), for example.

In the example shown in FIG. 7, the specific in-vehicle device group GP includes the function units 111J, 111K, 111L being target function units, as specific in-vehicle devices. Each target function unit has, stored therein in advance, ID information indicating CAN-ID corresponding to the target function unit, and address information indicating CAN-ID corresponding to another target function unit to be a transmission destination of a target packet.

For example, when a target function unit has received a data frame having a target packet stored therein, if CAN-ID included in the data frame is CAN-ID corresponding to the target function unit, the target function unit determines that the data frame has been transmitted thereto. Then, the target function unit adds, to the data frame, the CAN-ID indicated by the address information, and transmits the data frame. Thus, each of the function units 111J, 111K, 111L can circulate the target packet in the specific in-vehicle device group GP as shown by an arrow X2 in FIG. 7.

As described above, each target function unit can detect abnormality of another target function unit, based on the reception state of the target packet in the target function unit.

### Operation Flow

Next, an operation of each in-vehicle device performing a detection process in the in-vehicle communication system 301 according to the embodiment of the present disclosure will be described with reference to the drawings.

Each device in the in-vehicle communication system 301 includes a computer that includes a memory. An arithmetic processing unit such as a CPU in the computer reads out, from the memory, a program including a part or all of the steps in the sequence or flowchart below, and executes the program. Programs for the plurality of devices can be installed from outside. The programs for the plurality of devices are each distributed in a state of being stored in a storage medium, or via a communication line.

### [Operation Procedure of Target Packet Circulation Process]

### (Overall Operation)

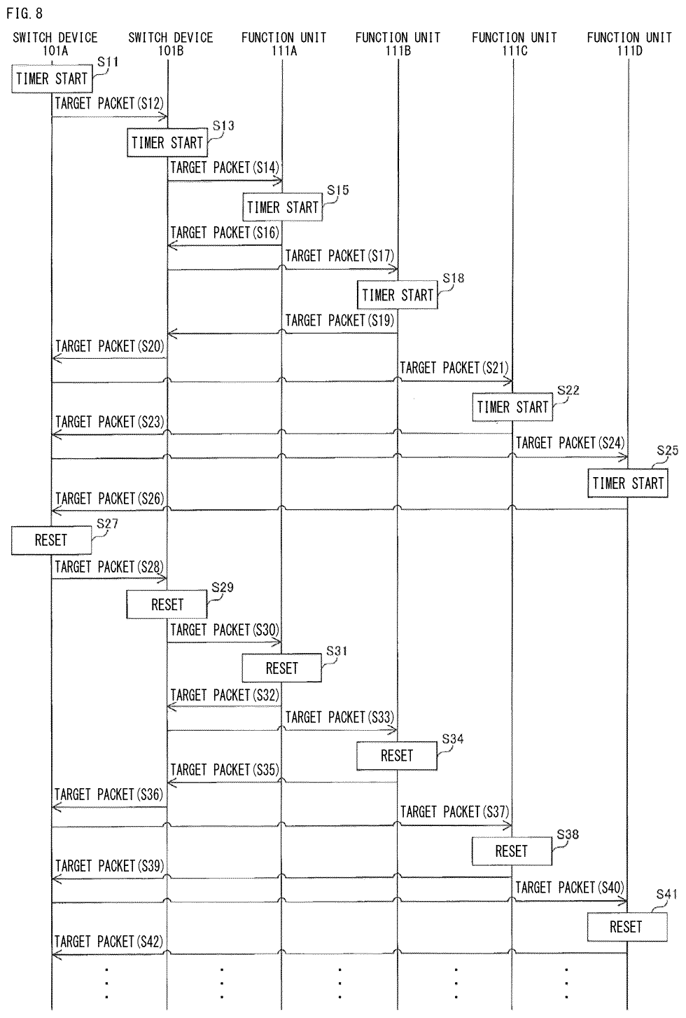

FIG. 8 shows an example of a sequence of a target packet circulation process in the in-vehicle communication system according to the embodiment of the present disclosure.

With reference to FIG. 1 and FIG. 8, firstly, the switch device 101A, for example, generates a target packet after activation, and starts the count operation of the timer 56 (step S11).

Next, the switch device 101A transmits the generated target packet to the switch device 101B (step S12).

Upon receiving the target packet transmitted from the switch device 101A, the switch device 101B starts the count operation of the timer 56 (step S13), and transmits the target packet to the function unit 111A (step S14).

Upon receiving the target packet transmitted from the switch device 101B, the function unit 111A starts the count operation of the timer 84 (step S15), and transmits the target packet to the switch device 101B (step S16).

Upon receiving the target packet transmitted from the function unit 111A, the switch device 101B transmits the target packet to the function unit 111B (step S17).

Upon receiving the target packet transmitted from the switch device 101B, the function unit 111B starts the count operation of the timer 84 (step S18), and transmits the target packet to the switch device 101B (step S19).

Upon receiving the target packet transmitted from the function unit 111B, the switch device 101B transmits the target packet to the switch device 101A (step S20).

Upon receiving the target packet transmitted from the switch device 101B, the switch device 101A transmits the target packet to the function unit 111C (step S21).

Upon receiving the target packet transmitted from the switch device 101A, the function unit 111C starts the count operation of the timer 84 (step S22), and transmits the target packet to the switch device 101A (step S23).

Upon receiving the target packet transmitted from the function unit 111C, the switch device 101A transmits the target packet to the function unit 111D (step S24).

Upon receiving the target packet transmitted from the switch device 101A, the function unit 111D starts the count operation of the timer 84 (step S25), and transmits the target packet to the switch device 101A (step S26).

Upon receiving the target packet transmitted from the function unit 111D, i.e., the target packet that has circulated through the specific in-vehicle device group GP, the function unit 111A resets the count value of the timer 56 (step S27), and transmits the target packet to the switch device 101B (step S28).

Upon receiving the target packet transmitted from the switch device 101A, i.e., the target packet that has circulated through the specific in-vehicle device group GP, the switch device 101B resets the count value of the timer 56 (step S29), and transmits the target packet to the function unit 111A (step S30).

Upon receiving the target packet transmitted from the switch device 101B, the function unit 111A resets the count value of the timer 84 (step S31), and transmits the target packet to the switch device 101B (step S32).

Upon receiving the target packet transmitted from the function unit 111A, the switch device 101B transmits the target packet to the function unit 111B (step S33).

Upon receiving the target packet transmitted from the switch device 101B, the function unit 111B resets the count value of the timer 84 (step S34), and transmits the target packet to the switch device 101B (step S35).

Next, upon receiving the target packet transmitted from the function unit 111B, the switch device 101B transmits the target packet to the switch device 101A (step S36).

Upon receiving the target packet transmitted from the switch device 101B, the switch device 101A transmits the target packet to the function unit 111C (step S37).

Upon receiving the target packet transmitted from the switch device 101A, the function unit 111C resets the count value of the timer 84 (step S38), and transmits the target packet to the switch device 101A (step S39).

Upon receiving the target packet transmitted from the function unit 111C, the switch device 101A transmits the target packet to the function unit 111D (step S40). Upon receiving the target packet transmitted from the switch device 101A, the function unit 111D resets the count value of the timer 84 (step S41), and transmits the target packet to the switch device 101A (step S42).

As described above, when the function units 111A, 111B, 111C, 111D each have received a target packet after transmission of the target packet, the function unit resets the count value of the timer 84, and transmits the target packet.

When the switch device 101A has received the target packet from the function unit 111D being a predetermined specific in-vehicle device, the switch device 101A resets the count value of the timer 56, and transmits the target packet. When the switch device 101B has received the target packet from the switch device 101A being a predetermined specific in-vehicle device, the switch device 101B resets the count value of the timer 56, and transmits the target packet.

As described above, when each specific in-vehicle device in the specific in-vehicle device group GP has received the target packet that has circulated through the specific in-vehicle device group GP, the specific in-vehicle device resets the count value of the timer 56 or the timer 84, and transmits the target packet to another specific in-vehicle device, thereby continuously circulating the target packet.

### (Relay Process by Switch Device 101A)

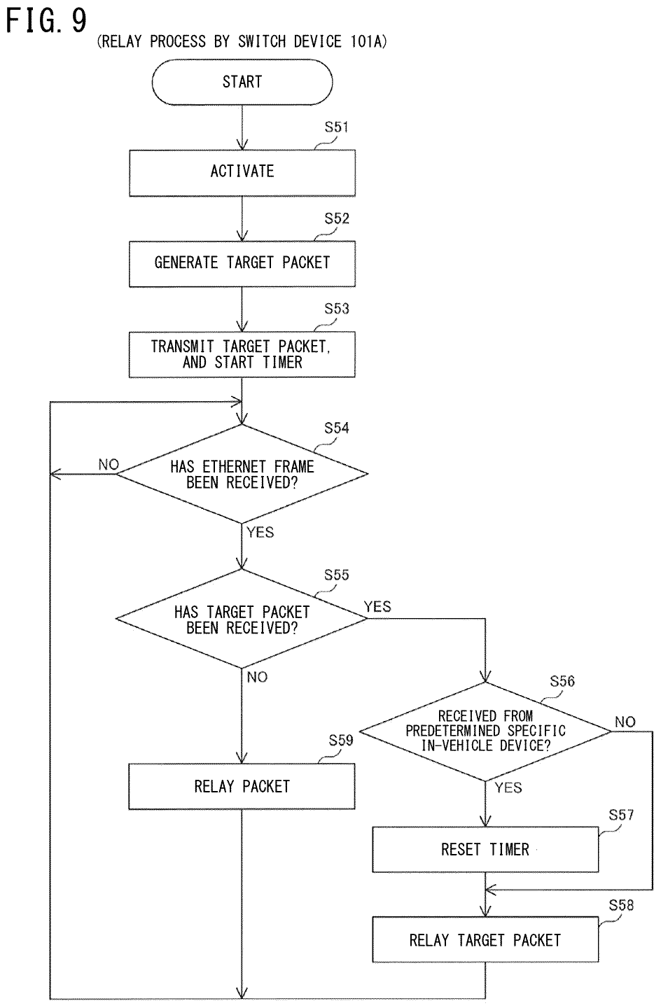

FIG. 9 is a flowchart showing an example of an operation procedure when a switch device, which generates a target packet, relays a target packet, in the in-vehicle communication system according to the embodiment of the present disclosure.

With reference to FIG. 9, firstly, when the switch device 101A has activated (step S51), the information processing unit 63 generates a target packet (step S52).

Next, the relay unit 51 transmits the target packet generated by the information processing unit 63 to the switch device 101B via the communication port Ps5, and causes the timer 56 to start the count operation. Thus, the detection process by the detection unit 64, which is described later, is started (step S53).

Next, the relay unit 51 waits until receiving an Ethernet frame (“NO” in step S54). Upon receiving an Ethernet frame (“YES” in step S54), the relay unit 51 confirms whether or not the Ethernet frame has the target packet stored therein (step S55).

Next, when the Ethernet frame has the target packet stored therein (“YES” in step S55), the relay unit 51 confirms whether or not the Ethernet frame has been transmitted from a predetermined specific in-vehicle device (step S56).

Next, when the Ethernet frame is, for example, an Ethernet frame from the function unit 111D that is the circulation destination of the target packet immediately before the switch device 101A (“YES” in step S56), the relay unit 51 resets the count value of the timer 56 (step S57).

Next, when the relay unit 51 has reset the count value of the timer 56 (step S57) or has received an Ethernet frame from an in-vehicle device other than the function unit 111D (“NO” in step S56), the relay unit 51 specifies a communication port Ps to be an output destination of the Ethernet frame, with reference to the port table Tb1 stored in the storage unit 53. Then, the relay unit 51 transmits the Ethernet frame from the specified communication port Ps (step S58).

Then, the relay unit 51 waits until receiving an Ethernet frame again (step S54).

When the relay unit 51 has received an Ethernet frame having stored therein a packet other than the target packet (“NO” in step S55), the relay unit 51 specifies a communication port Ps corresponding to a transmission destination MAC address included in the Ethernet frame, with reference to the address table Tb2 stored in the storage unit 53, for example. Then, the relay unit 51 performs a relay process of transmitting the Ethernet frame from the specified communication port Ps (step S59).

Then, the relay unit 51 waits until receiving the Ethernet frame again (step S54).

It is assumed that, as in Modification 1 described above, the switch device 101A does not hold the port table Tb1. In this case, in relaying the target packet (step S58), the switch device 101A specifies a communication port Ps corresponding to a transmission destination MAC address included in the received Ethernet frame, with reference to the address table Tb2, for example. Then, the switch device 101A transmits the Ethernet frame from the specified communication port Ps.

### (Relay Process by Switch Device 101B)

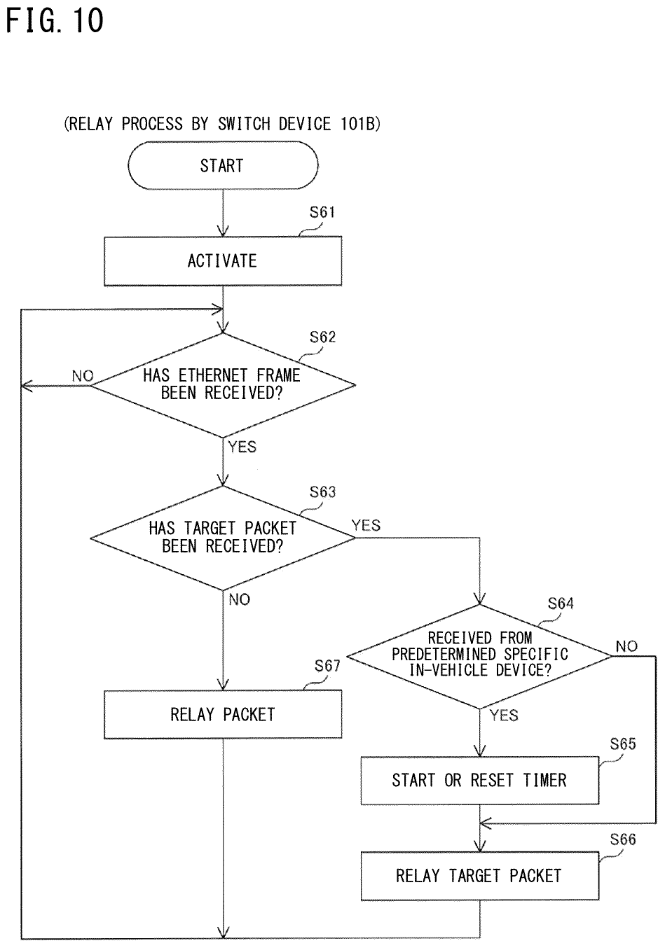

FIG. 10 is a flowchart showing an example of an operation procedure when a switch device, which does not generate a target packet, relays a target packet, in the in-vehicle communication system according to the embodiment of the present disclosure.

With reference to FIG. 10, firstly, when the switch device 101B has activated (step S61), the relay unit 51 waits until receiving an Ethernet frame (“NO” in step S62). Upon receiving an Ethernet frame (“YES” in step S62), the relay unit 51 confirms whether or not the Ethernet frame has a target packet stored therein (step S63).

When the Ethernet frame has a target packet stored therein (“YES” in step S63), the relay unit 51 confirms whether or not the Ethernet frame has been transmitted from a predetermined specific in-vehicle device (step S64).

Next, it is assumed that the Ethernet frame is, for example, an Ethernet frame having been transmitted from the switch device 101A that is a circulation destination of the target packet immediately before the switch device 101B (“YES” in step S64). In this case, the relay unit 51 causes the timer 56 to start the count operation, and thus, a detection process by the detection unit 64, described later, is started; on the other hand, if the count operation of the timer 56 has already been started, the relay unit 51 resets the count value (step S65).

Next, when the relay unit 51 has started the count operation of the timer 56 or has reset the count value (step S65) or when the relay unit 51 has received an Ethernet frame from an in-vehicle device other than the switch device 101A (“NO” in step S64), the relay unit 51 specifies a communication port Ps to be an output destination of the received Ethernet frame, with reference to the port table Thl stored in the storage unit 53. Then, the relay unit 51 transmits the Ethernet frame to the specified communication port Ps (step S66).

Then, the relay unit 51 waits unit receiving an Ethernet frame again (step S62).

On the other hand, when the relay unit 51 has received an Ethernet frame in which a packet other than the target packet is stored (“NO” in step S63), the relay unit 51 specifies a communication port Ps corresponding to a transmission destination MAC address included in the Ethernet frame, with reference to the address table Tb2 stored in the storage unit 53, for example. Then, the relay unit 51 performs a relay process of transmitting the Ethernet frame from the specified communication port Ps (step S67).

Then, the relay unit 51 waits until receiving an Ethernet frame again (step S62).

It is assumed that the switch device 101B does not hold the port table Tb1, as in Modification 1 described above. In this case, in relaying the target packet (step S66), the switch device 101B specifies a communication port Ps corresponding to a transmission destination MAC address included in the received Ethernet frame, with reference to the address table Tb2, for example. Then, the switch device 101B transmits the Ethernet frame from the specified communication port Ps.

### (Circulation Process by Target Function Unit)

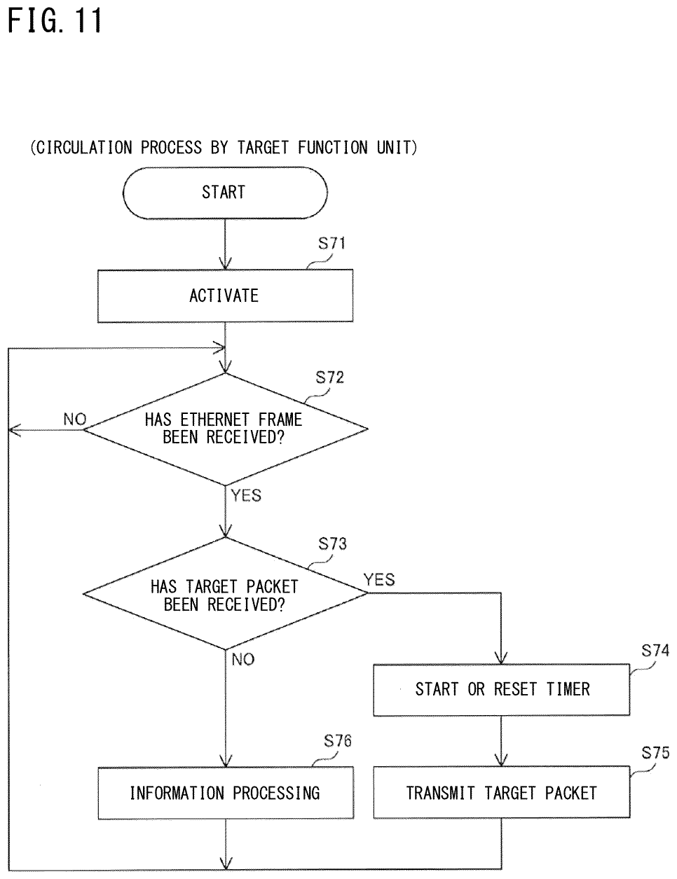

FIG. 11 is a flowchart showing an example of an operation procedure when a target function unit in the in-vehicle communication system performs a target packet circulation process, according to the embodiment of the present disclosure. Here, the operation of the function unit 111A as a target function unit will be described. The operations of the function units 111B, 111C, 111D being the other target function units are the same as the operation of the function unit 111A.

With reference to FIG. 11, firstly, when the function unit 111A has activated (step S71), the communication unit 81 waits until receiving an Ethernet frame (“NO” in step S72). Upon receiving an Ethernet frame (“YES” in step S72), the communication unit 81 confirms whether or not the Ethernet frame has a target packet stored therein (step S73).

When the Ethernet frame has a target packet stored therein (“YES” in step S73), the communication unit 81 causes the timer 84 to start a count operation, and thus, a detection process by the detection unit 92 described later is started; on the other hand, if the count operation of the timer 84 has already been started, the communication unit 81 resets the count value (step S74).

Next, the relay unit 51 transmits the received Ethernet frame from the communication port Pe (step S75), and waits until receiving an Ethernet frame again (step S72).

On the other hand, when the relay unit 51 has received an Ethernet frame in which a packet other than the target packet is stored (“NO” in step S73), the relay unit 51, for example, extracts information included in this packet, and performs normal information processing using the extracted information (step S76). Then, the relay unit 51 waits until receiving an Ethernet frame again (step S72).

It is assumed that the function unit 111A holds in advance address information of the other target function units to be transmission destinations of the target packet, as in Modification 1 described above. In this case, in transmitting the target packet (step S75), the function unit 111A overwrites the address of the received Ethernet frame with the MAC address indicated by the address information, with reference to the address information, for example, and transmits the target packet.

### [Operation Procedure of Detection Process]

### (Detection Process by Switch Devices 101A, 101B)

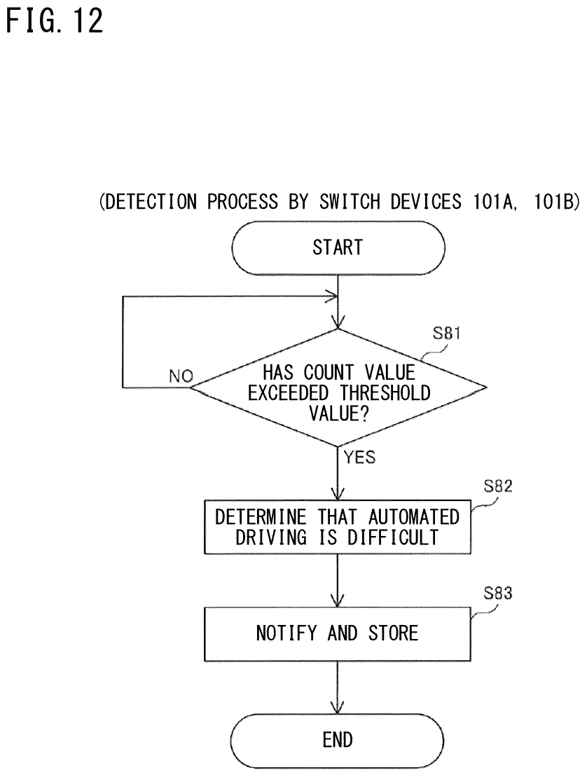

FIG. 12 is a flowchart showing an example of an operation procedure when the switch device in the in-vehicle communication system performs a detection process, according to the embodiment of the present disclosure.

With reference to FIG. 12, firstly, the detection unit 64 checks the count value of the timer 56 to measure the circulation time of the target packet, and monitors whether or not the count value exceeds the threshold value (step S81).

If the count value has been reset before exceeding the threshold value (“NO” in step S81), the detection unit 64 again performs monitoring of the count value after the reset (step S81).

On the other hand, when the count value has exceeded the threshold value (“YES” in step S81), the detection unit 64 determines that automated driving of the vehicle 1 is difficult because abnormality occurs in one or a plurality of specific in-vehicle devices in the specific in-vehicle device group GP, and outputs determination information indicating the determination result to the notification unit 55 (step S82).

Upon receiving the determination information from the detection unit 64, the notification unit 55, for example, notifies the user of the content of the determination information, and stores the determination information in association with the present time, etc., in the storage unit 53. In addition, the notification unit 55 notifies the function units 111A, 111B, 111C, 111D, which are the other specific in-vehicle devices in the specific in-vehicle device group GP, of the content of the determination information (step S83).

### (Detection Process by Target Function Unit)

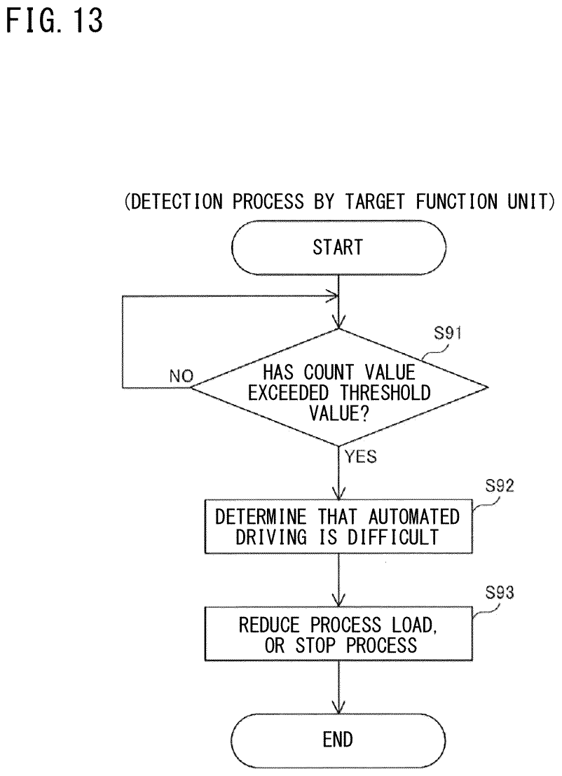

FIG. 13 is a flowchart showing an example of an operation procedure when a target function unit in the in-vehicle communication system performs a detection process, according to the embodiment of the present disclosure. Here, the operation of the function unit 111A being a target function unit will be described. The operations of the function units 111B, 111C, 111D being the other target function units are the same as the operation of the function unit 111A.

With reference to FIG. 13, firstly, the detection unit 92 checks the count value of the timer 84 to measure the circulation time of the target packet, and monitors whether or not the count value exceeds the threshold value (step S91).

If the count value has been reset before exceeding the threshold value (“NO” in step S91), the detection unit 92 again performs monitoring of the count value after the reset (step S91).

On the other hand, when the count value has exceeded the threshold value (“YES” in step S91), the detection unit 92 determines that automated driving of the vehicle 1 is difficult because abnormality occurs in one or a plurality of specific in-vehicle devices in the specific in-vehicle device group GP, and outputs determination information indicating the determination result to the information processing unit 91 (step S92).

Upon receiving the determination information from the detection unit 92, the information processing unit 91 changes the process, other than the detection process, performed by the function unit 111A to a process with low load, or stops the process (step S93).

### Modification 3

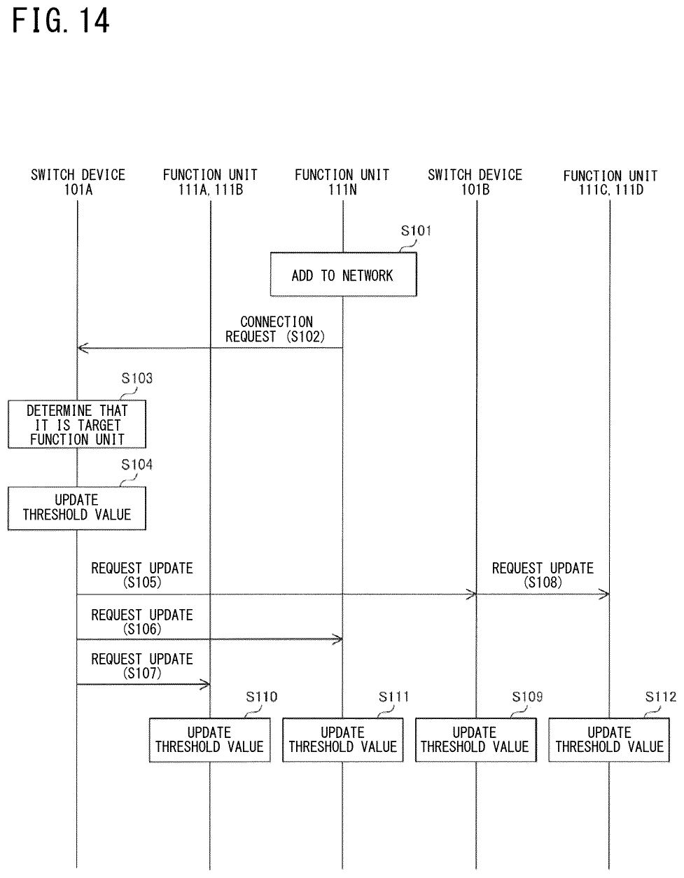

The in-vehicle communication system 301 may be able to cope with addition of a new specific in-vehicle device to the in-vehicle network. FIG. 14 shows an example of a sequence of a threshold value updating process due to addition of a specific in-vehicle device, in Modification 3 of the in-vehicle communication system according to the embodiment of the present disclosure.

As described above, in the detection process, if the first in-vehicle device in the specific in-vehicle device group GP cannot confirm circulation of the target packet even after the time elapsed from transmission of the target packet has reached or exceeded the predetermined threshold value (i.e., the threshold value of the circulation time), that is, if the target packet does not return after going around the specific in-vehicle device group GP, the first in-vehicle device determines that abnormality occurs. When a new specific in-vehicle device has been added to the specific in-vehicle device group GP, the first in-vehicle device may perform an update process of updating the threshold value.

For example, when another first in-vehicle device performing the detection process is present in the specific in-vehicle device group GP, the first in-vehicle device performing the update process notifies the other first in-vehicle device of the updated threshold value. The other first in-vehicle device performs the detection process by using the notified updated threshold value.

More specifically, with reference to FIG. 14, firstly, a function unit 111N is added to the network of the vehicle 1 (step S101), and the function unit 111N transmits a connection request to the switch device 101A (step S102).

Upon receiving the connection request, the switch device 101A detects the function unit 111N, and determines that the function unit 111N is a target function unit, based on an ID included in the connection request, for example (step S103).

Next, the switch device 101A updates the threshold value of the circulation time. More specifically, the detection unit 64 in the switch device 101A changes the threshold value stored in the storage unit 53, based on a correction value included in the connection request from the function unit 111N, for example. For example, a correction value in consideration of the propagation delay time of data between in-vehicle devices, the data processing time in the function unit 111N, and the like, is stored in advance in the storage unit 83 of the function unit 111N (step S104).

Next, the switch device 101A transmits an update request indicating the updated threshold value to the function units 111A, 111B, 111N and the switch device 101B (steps S105 to S107).

Next, the switch device 101B transmits the update request received from the switch device 101A, to the function units 111C, 111D (step S108).

Next, the switch device 101B updates the threshold value stored in the storage unit 53, to the threshold value indicated by the received update request (step S109). In addition, each of the function units 111A, 111B, 111C, 111D, 111N updates the threshold value stored in the storage unit 83, to the threshold value indicated by the received update request (steps S110 to S112).

The specific in-vehicle device group GP may be configured as follows. That is, when another first in-vehicle device performing the detection process is present in the specific in-vehicle device group GP, the first in-vehicle device performing the update process notifies the other first in-vehicle device of the correction value of the threshold value. The other first in-vehicle device updates the threshold value, based on the notified correction value, and performs the detection process by using the updated threshold value.

More specifically, in the sequence shown in FIG. 14, the switch device 101A transmits an update request indicating the correction value to the function units 111A, 111B, 111N and the switch device 101B (steps S105 to S107).

Next, the switch device 101B transmits the update request received from the switch device 101A to the function units 111C, 111D (step S108).

Next, the switch device 101B updates the threshold value stored in the storage unit 53, based on the correction value indicated by the received update request (step S109). In addition, each of the function units 111A, 111B, 111C, 111D, 111N updates the threshold value stored in the storage unit 83, based on the correction value indicated by the received update request (steps S110 to S112).

The correction value may not necessarily be included in the connection request from the function unit 111N being the added function unit, and a correction value corresponding to an additional function unit may be stored in advance in the storage unit 53. The storage unit 53 may store therein different correction values for the switch devices and the target function units. The storage unit 53 may store therein correction values by the types of target function units, or may store therein a common correction value for the various types of target function units. The correction value may be registered or updated by an operator using a maintenance tool or the like.

As described above, when one or a plurality of first in-vehicle devices being a part of the specific in-vehicle device group GP performs a detection process, the switch device 101A may selectively transmit an update request to the first in-vehicle devices performing the detection process.

In the case of Modification 2 shown in FIG. 7 in which the in-vehicle communication system 301 includes no switch device 101, some or all of the target function units detect the function unit 111N being a target function unit and perform update of the threshold value and transmission of the update request as shown in FIG. 14.

The processes (functions) of the above embodiment are realized by processing circuitry including one or a plurality of processors. The processing circuitry may be configured as an integrated circuit or the like in which one or a plurality of memories, various analog circuits, and various digital circuits are combined, in addition to the one or the plurality of processors. The one or the plurality of memories have stored therein a program (command) that causes the one or the plurality of processors to execute the above processes. The one or the plurality of processors may execute the above processes according to the program that is read from the one or the plurality of memories, or may execute the above processes according to a logic circuit that is designed in advance to execute the above processes. The processors may be various processors conforming to control of a computer, such as a CPU (Central Processing Unit), a GPU (Graphics Processing Unit), a DSP (Digital Signal Processor), an FPGA (Field Programmable Gate Array), and an ASIC (Application Specific Integrated Circuit). The plurality of processors physically separated from each other may execute the above processes in cooperation with each other. For example, the processors respectively installed in a plurality of physically separated computers may execute the above processes in cooperation with each other via a network such as a LAN (Local Area Network), a WAN (Wide Area Network), and the Internet.

As described above, in the in-vehicle communication system 301, the switch device 101, and the abnormality detection method according to the embodiment of the present disclosure, the above configurations and methods allow abnormality of an in-vehicle device in the in-vehicle communication system 301 to be more reliably detected by using an easier method.

The embodiments disclosed herein are merely illustrative in all aspects and should not be recognized as being restrictive. The scope of the present invention is defined by the scope of the claims rather than the meaning described above, and is intended to include meaning equivalent to the scope of the claims and all modifications within the scope.

### REFERENCE SIGNS LIST

1 vehicle
10 Ethernet cable
11 CAN bus
51 relay unit
52, 82 processing unit
53, 83 storage unit
55 notification unit
56, 84 timer
63, 91 information processing unit
64, 92 detection unit
81 communication unit
101, 101A, 101B switch device (specific in-vehicle device)
111 function unit
111A to 111D, 111J to 111L, 111N function unit (target function unit, specific in-vehicle device)
111E to 111H, 111M function unit (non-target function unit)
301 in-vehicle communication system
GP specific in-vehicle device group
Pe, Ps, Ps1 to Ps5 communication port
Tb1 port table
Tb2 address table
X1, X2 arrow

1. An in-vehicle communication system provided with an in-vehicle device group including four or more in-vehicle devices, wherein
a specific in-vehicle device group circulates a specific target packet, the specific in-vehicle device group being a part of the in-vehicle device group and including three or more specific in-vehicle devices being the in-vehicle devices, and
a first in-vehicle device being the specific in-vehicle device performs a detection process of detecting abnormality of a specific in-vehicle device, other than the first in-vehicle device, in the specific in-vehicle device group, based on a reception state of the target packet.

2. The in-vehicle communication system according to claim 1, wherein
the specific in-vehicle device group includes a plurality of first in-vehicle devices, and at least one of the plurality of first in-vehicle devices is a switch device that relays a packet between a plurality of in-vehicle devices, and
if one or more first in-vehicle devices, other than the switch device, in the specific in-vehicle device group detects abnormality of an in-vehicle device in the detection process, the one or more first in-vehicle devices changes a process other than the detection process performed by the first in-vehicle device to a process with low load, or stops the process.

3. The in-vehicle communication system according to claim 1, wherein
all the specific in-vehicle devices in the specific in-vehicle device group are the first in-vehicle devices.

4. The in-vehicle communication system according to claim 1, wherein
the specific in-vehicle device group includes, as the specific in-vehicle devices, a switch device that relays a packet between the plurality of in-vehicle devices, a second in-vehicle device, and a third in-vehicle device, and
the switch device holds rule information indicating a circulation rule of the target packet, and, based on the rule information, transmits the target packet received from the second in-vehicle device to the third in-vehicle device.

5. The in-vehicle communication system according to claim 1, wherein
the specific in-vehicle device group includes, as the specific in-vehicle devices, a switch device that relays a packet between the plurality of in-vehicle devices, a second in-vehicle device, and a third in-vehicle device, and
the second in-vehicle device overwrites a destination address of the target packet received from the switch device with an address of the third in-vehicle device, and transmits the target packet to the switch device.

6. The in-vehicle communication system according to claim 1, wherein
in the detection process, if the first in-vehicle device cannot confirm circulation of the target packet even when an elapsed time from transmission of the target packet has reached or exceeded a predetermined threshold value, the first in-vehicle device determines that the abnormality occurs, and
when a new specific in-vehicle device has been added to the specific in-vehicle device group, the first in-vehicle device performs an update process of updating the predetermined threshold value.

7. The in-vehicle communication system according to claim 6, wherein
the first in-vehicle device performing the update process notifies another first in-vehicle device in the specific in-vehicle device group, of the updated threshold value, and
the other first in-vehicle device performs the detection process by using the notified updated threshold value.

8. The in-vehicle communication system according to claim 6, wherein
the first in-vehicle device performing the update process notifies another first in-vehicle device in the specific in-vehicle device group, of a correction value of the threshold value, and
the other first in-vehicle device updates the threshold value, based on the notified correction value, and performs the detection process by using the updated threshold value.

9. The in-vehicle communication system according to claim 1, wherein
the specific in-vehicle device group includes three or more specific in-vehicle devices that are essential for automated driving of a vehicle.

10. A switch device in an in-vehicle communication system provided with an in-vehicle device group that includes four or more in-vehicle devices including the switch device, the switch device comprising:
a relay unit configured to relay a packet between the in-vehicle devices; and
a detection unit configured to detect abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

11.-12. (canceled)

13. A non-transitory computer-readable storage medium having, stored therein, a abnormality detection program used in a switch device in an in-vehicle communication system provided with an in-vehicle device group including four or more in-vehicle devices including the switch device,
the program causing a computer to function as:
a relay unit configured to relay a packet between the in-vehicle devices; and
a detection unit configured to detect abnormality of a specific in-vehicle device, other than the switch device, in the specific in-vehicle device group, based on a reception state of a specific target packet that circulates through a specific in-vehicle device group that is a part of the in-vehicle device group and includes three or more specific in-vehicle devices being the in-vehicle devices.

14. The in-vehicle communication system according to claim 2, wherein
all the specific in-vehicle devices in the specific in-vehicle device group are the first in-vehicle devices.

15. The in-vehicle communication system according to claim 2, wherein
the specific in-vehicle device group includes, as the specific in-vehicle devices, a switch device that relays a packet between the plurality of in-vehicle devices, a second in-vehicle device, and a third in-vehicle device, and
the switch device holds rule information indicating a circulation rule of the target packet, and, based on the rule information, transmits the target packet received from the second in-vehicle device to the third in-vehicle device.

16. The in-vehicle communication system according to claim 3, wherein
the specific in-vehicle device group includes, as the specific in-vehicle devices, a switch device that relays a packet between the plurality of in-vehicle devices, a second in-vehicle device, and a third in-vehicle device, and
the switch device holds rule information indicating a circulation rule of the target packet, and, based on the rule information, transmits the target packet received from the second in-vehicle device to the third in-vehicle device.

17. The in-vehicle communication system according to claim 14, wherein
the specific in-vehicle device group includes, as the specific in-vehicle devices, a switch device that relays a packet between the plurality of in-vehicle devices, a second in-vehicle device, and a third in-vehicle device, and
the switch device holds rule information indicating a circulation rule of the target packet, and, based on the rule information, transmits the target packet received from the second in-vehicle device to the third in-vehicle device.

18. The in-vehicle communication system according to claim 2, wherein
the specific in-vehicle device group includes, as the specific in-vehicle devices, a switch device that relays a packet between the plurality of in-vehicle devices, a second in-vehicle device, and a third in-vehicle device, and
the second in-vehicle device overwrites a destination address of the target packet received from the switch device with an address of the third in-vehicle device, and transmits the target packet to the switch device.

19. The in-vehicle communication system according to claim 3, wherein
the specific in-vehicle device group includes, as the specific in-vehicle devices, a switch device that relays a packet between the plurality of in-vehicle devices, a second in-vehicle device, and a third in-vehicle device, and
the second in-vehicle device overwrites a destination address of the target packet received from the switch device with an address of the third in-vehicle device, and transmits the target packet to the switch device.

20. The in-vehicle communication system according to claim 14, wherein
the specific in-vehicle device group includes, as the specific in-vehicle devices, a switch device that relays a packet between the plurality of in-vehicle devices, a second in-vehicle device, and a third in-vehicle device, and
the second in-vehicle device overwrites a destination address of the target packet received from the switch device with an address of the third in-vehicle device, and transmits the target packet to the switch device.

21. The in-vehicle communication system according to claim 2, wherein
in the detection process, if the first in-vehicle device cannot confirm circulation of the target packet even when an elapsed time from transmission of the target packet has reached or exceeded a predetermined threshold value, the first in-vehicle device determines that the abnormality occurs, and
when a new specific in-vehicle device has been added to the specific in-vehicle device group, the first in-vehicle device performs an update process of updating the predetermined threshold value.

22. The in-vehicle communication system according to claim 3, wherein
in the detection process, if the first in-vehicle device cannot confirm circulation of the target packet even when an elapsed time from transmission of the target packet has reached or exceeded a predetermined threshold value, the first in-vehicle device determines that the abnormality occurs, and
when a new specific in-vehicle device has been added to the specific in-vehicle device group, the first in-vehicle device performs an update process of updating the predetermined threshold value.
